(19) United States
(12) Patent Application Publication
(10) Pub. No.: US 2011/0150401 A1
(43) Pub. Date: Jun. 23, 2011

(54) OPTICAL WIRING CABLE

(75) Inventor: Hideto Furuyama, Yokohama-shi (JP)

(73) Assignee: KABUSHIKI KAISHA TOSHIBA, Tokyo (JP)

(21) Appl. No.: 12/888,675

(22) Filed: Sep. 23, 2010

(30) Foreign Application Priority Data
Dec. 18, 2009 (JP) 2009-288322

(51) Int. Cl. G02B 6/36; G02B 6/42

(52) U.S. Cl. 385/89

(57) ABSTRACT

According to one embodiment, an optical wiring cable including a first optical interconnection paths, a first optical transmission unit incorporated in a first connector, and configured to transmit an optical signal to the first optical interconnection paths, a first optical reception unit incorporated in a second connector, and configured to receive an optical signal from the first optical interconnection paths, a second optical interconnection paths, a second optical transmission unit incorporated in the second connector, and configured to transmit an optical signal to the second optical interconnection paths, a second optical reception unit incorporated in the first connector, and configured to receive an optical signal from the second optical interconnection paths, and a control unit configured to detect a combination of electronic apparatuses to which the first and the second connector are to be connected, and control power supply to the optical transmission units and the optical reception units.

### CROSS-REFERENCE TO RELATED APPLICATIONS

This application is based upon and claims the benefit of priority from Japanese Patent Application No. 2009-288322, filed Dec. 18, 2009; the entire contents of which are incorporated herein by reference.

### FIELD

Embodiments described herein relate generally to an optical wiring cable configured to convert an electrical signal into an optical signal, and transmit the converted optical signal.

### BACKGROUND

In recent years, owing to the improvement of electronic devices such as bipolar transistors, field-effect transistors, and the like in the performance, tremendous progress of large-scale integration (LSI) in the working speed has been attempted. Concomitantly with this, a speed limit of an electrical wire connecting between LSIs, and electromagnetic noise malfunction have now become problematic. Particularly, the above problem is now being actualized by the high definition of the display device, and enlargement of the video data.

In order to cope with such a wiring problem, some of optical wiring apparatuses configured to carry out signal transmission by using light are proposed. Further, in carrying out optical wiring, for the purpose of facilitating control communication between the light transmission side and light reception side or power source wiring, an optical wiring cable which is just like a composite of the optical wiring and electrical wire is also proposed (for example, JP-A 2004-179733 (KOKAI)).

### BRIEF DESCRIPTION OF THE DRAWINGS

FIG. 1 is a schematic configuration diagram showing an optical wiring cable according to a first embodiment.

FIG. 2 is a schematic configuration diagram showing an optical wiring cable according to a second embodiment.

FIG. 3 is a view showing an example of the specific configuration of an optical transmission/reception unit used in the second embodiment.

FIG. 4 is a view for explaining an operation mode in the second embodiment.

FIG. 5 is a schematic configuration diagram showing an optical wiring cable according to a third embodiment.

FIG. 6 is a view showing an example of the specific configuration of an optical transmission/reception unit used in the third embodiment.

FIG. 7 is a schematic configuration diagram showing an optical wiring cable according to a fourth embodiment.

FIG. 8 is a schematic configuration diagram showing an optical wiring cable according to a fifth embodiment.

FIG. 9 is a schematic configuration diagram showing an optical wiring cable according to a sixth embodiment.

### DETAILED DESCRIPTION

According to this embodiment, an optical wiring cable configured to convert an electrical signal into an optical signal, and transmit the converted optical signal, comprises a first optical interconnection path configured to transmit an optical signal in a first direction, a first optical transmission unit incorporated in a first connector, and configured to transmit an optical signal to the first optical interconnection path, a first optical reception unit incorporated in a second connector, and configured to receive an optical signal from the first optical interconnection path, a second optical interconnection path configured to transmit an optical signal in a direction reverse to the first direction, a second optical transmission unit incorporated in the second connector, and configured to transmit an optical signal to the second optical interconnection path, a second optical reception unit incorporated in the first connector, and configured to receive an optical signal from the second optical interconnection path, and a control unit configured to detect a combination of electronic apparatuses to which the first connector and the second connector are to be connected, and control power supply to the optical transmission units and the optical reception units in accordance with the detected combination.

Hereinafter, embodiments of the present invention will be described below while referring to the drawings. Here, although a description will be given by taking some specific configurations as examples, a configuration having the same function can be implemented in the same manner, and the present invention is not to be limited to the following embodiments.

In the optical wiring, transmission is generally the simplex transmission with the exception of some low-speed half-duplex link, and expensive wavelength multiplexing link. Further, in the optical wiring in which an optical interface (optical transmission unit, optical reception unit) is incorporated in the cable, and the input/output is constituted of an electrical connector, there is the problem that although the input/output unit is an electrical connector, if the transmission side and the reception side are subjected to reverse insertion, signal transmission incapability is caused. Further, in the data transmission using the optical wiring, each of the transmission side and reception side requires a power source for the optical interface. If no control is carried out for the power source, there is also the problem that useless power is consumed even at the non-operating time, and the life of the active element in the optical interface is shortened more than necessary. In the following embodiments, these problems will be solved.

### First Embodiment

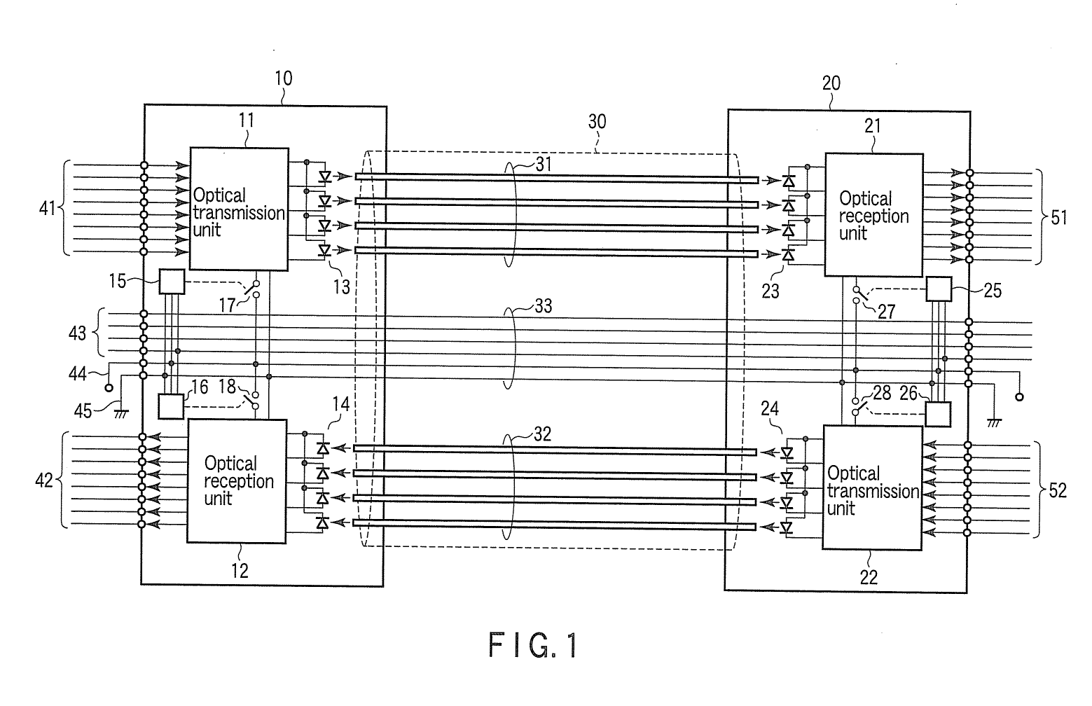

FIG. 1 is a schematic configuration diagram showing an optical wiring cable according to a first embodiment.

This device is constituted of a first connector 10, second connector 20, and optoelectronic interconnection 30 connecting these connectors 10 and 20 to each other.

The optoelectronic interconnection 30 includes a plurality of first optical interconnection paths 31 configured to transmit an optical signal from the first connector 10 to the second connector 20, a plurality of second optical interconnection paths 32 configured to transmit an optical signal from the second connector 20 to the first connector 10, and electrical wires 33 configured to electrically connect the first and second connectors 10 and 20 to each other. Each of the optical interconnection paths 31 and 32 is constituted of an optical fiber, optical waveguide or the like.

In the first connector 10, an optical transmission unit (first optical transmission unit) 11 configured to transmit an optical signal to the first optical interconnection paths 31, and optical reception unit (second optical reception unit) 12 configured to receive an optical signal from the second optical interconnection paths 32 are incorporated.

The optical transmission unit 11 is provided with light-emitting elements 13 such as semiconductor lasers each configured to convert an electrical signal into an optical signal. Furthermore, on the optical transmission unit 11 side, an optical link control unit 15 configured to detect a state of connection of an electronic apparatus to the optical transmission unit 11, and switch 17 configured to turn on/off supply of power to the optical transmission unit 11 by the control of the control unit 15 are provided. The optical reception unit 12 is provided with light receiving elements 14 such as PIN photodiodes each configured to convert an optical signal into an electrical signal. Furthermore, on the optical reception unit 12 side, an optical link control unit 16 configured to detect a state of connection of an electronic apparatus to the optical reception unit 12, and switch 18 configured to turn on/off supply of the power to the optical reception unit 12 by the control of the control unit 16 are provided.

An optical reception unit 21 is provided with light receiving elements 23 such as PIN photodiodes. Furthermore, on the optical reception unit 21 side, an optical link control unit 25 configured to detect a state of connection of an electronic apparatus to the optical reception unit 21, and switch 27 configured to turn on/off supply of the power to the optical reception unit 21 by the control of the control unit 25 are provided. An optical transmission unit 22 is provided with light-emitting elements 24 such as semiconductor lasers. Furthermore, on the optical transmission unit 22 side, an optical link control unit 26 configured to detect a state of connection of an electronic apparatus to the optical transmission unit 22, and switch 28 configured to turn on/off supply of the power to the optical transmission unit 22 by the control of the control unit 26 are provided.

It should be noted that a reference symbol 41 in FIG. 1 denotes data signal lines (high-speed signal lines) to be connected to electrical input terminals of the optical transmission unit 11, reference symbol 42 denotes data signal lines (high-speed signal lines) to be connected to electrical output terminals of the optical reception unit 12, reference symbol 51 denotes data signal lines (high-speed signal lines) to be connected to electrical output terminals of the optical reception unit 21, and reference symbol 52 denotes data signal lines (high-speed signal lines) to be connected to electrical input terminals of the optical transmission unit 22. Further, a reference symbol 43 denotes control signal lines (low-speed signal lines), reference symbol 44 denotes a power supply line, reference symbol 45 denotes a grounding line, and these lines 43, 44, and 45 are connected to the electrical wires 33.

The optical link control units 15, 16, 25, and 26 are each connected to part of the control signal lines 43, power supply line 44, and grounding line 45. Each of the optical link control units 15, 16, 25, and 26 is configured to carry out detection of fitting of the optical wiring cable itself to a corresponding apparatus, a type (data transmission apparatus or data reception apparatus) of the apparatus to which the optical wiring cable is fitted, and power-on-state of the apparatus to which the cable is fitted. Further, each of the optical link control units 15, 16, 25, and 26 is configured to control each of the switches 17, 18, 28, and 28 in accordance with the operation mode in which the detection is carried out.

Next, an operation of this device configured as described above will be described below.

First, each of the optical link control units 15, 16, 25, and 26 carries out detection of fitting of the optical wiring cable itself to a corresponding apparatus, and a type (data transmission apparatus or data reception apparatus) of the apparatus to which the optical wiring cable is fitted by means of the electrical wires (control signal lines 43, power supply line 44, and grounding line 45). It should be noted that even when the apparatus is connected to the optical wiring cable, if the power of the connected apparatus is in the off-state, the apparatus is regarded as being not connected.

As a result of this, when it is detected that the electrical input terminals of the optical transmission unit 11 are connected to the data transmission apparatus, and electrical output terminals of the optical reception unit 21 are connected to the data reception apparatus, the switches 17 and 27 are turned on (first operation mode). When it is detected that the electrical input terminals of the optical transmission unit 22 are connected to the data transmission apparatus, and electrical output terminals of the optical reception unit 12 are connected to the data reception apparatus, the switches 18 and 28 are turned on (second operation mode). Further, when it is detected that the electrical input terminals of the optical transmission unit 11 are connected to the data transmission apparatus, electrical output terminals of the optical reception unit 21 are connected to the data reception apparatus, the electrical input terminals of the optical transmission unit 22 are connected to the data transmission apparatus, and electrical output terminals of the optical reception unit 12 are connected to the data reception apparatus, all the switches 17, 18, 27, and 28 are turned on (third operation mode).

On the other hand, when the optical wiring cable itself is not fitted to the corresponding apparatus or the detection result of the apparatus to which the cable is to be fitted is other than the above combinations, all the switches 17, 18, 27, and 28 are left turned off.

In general, a connection destination of the optical transmission unit 11, optical reception unit 21, optical reception unit 12, and optical transmission unit 22 can be specified by the mechanical shape of the connectors 10 and 20. Accordingly, it is detected whether or not the connectors 10 and 20 are connected on the basis of the combination of the data transmission apparatus and data reception apparatus (or the opposite of this). Thereafter, it is sufficient when the fitting destination is the data transmission apparatus, if the power switch of the optical transmission unit side is turned on, and when the fitting destination is the data reception apparatus, if the power switch of the optical reception unit side is turned on.

As described previously, detection of the connection destinations of all the connection terminals can be used when it is determined whether or not the apparatus to which the cable is to be fitted is an apparatus capable of carrying out bidirectional transmission or when it is determined whether or not the bidirectional transmission is to be carried out.

As described above, according to this embodiment, in a situation in which data transmission is not necessary, for example, when nothing is connected to one end of an optical wiring cable or when transmission-dedicated apparatuses (or reception-dedicated apparatuses) are connected to each other by mistake, it is possible to stop power supply to the units 11, 12, 21, and 22. That is, when the operation of the signal transmission link is not necessary, it is possible to prevent the optical link (optical transmission unit and optical reception unit) from being brought into the operating state. This makes it possible to prevent power from being uselessly consumed, and to prevent the life of the optical wiring cable from being uselessly shortened by the operation of the active elements (light-emitting elements and light receiving elements) at the non-operating time. That is, it is possible to cope with reverse connection, and bidirectional transmission, prevent power from being uselessly consumed, and prevent the life of the optical interface from being shortened more than necessary.

It should be noted that regarding the detection of fitting of the optical wiring cable itself to the corresponding apparatus, a function of determining improper connection such as a case where the cable is connected to data transmission apparatuses or data reception apparatuses, and carrying out any alarm display may be added thereto.

Further, like in this embodiment, when the electrical terminals of each of the optical transmission unit 11, and optical reception unit 12 are provided independently of each other in the connector 10, the connector 10 is generally connected to one transmission/reception apparatus. Accordingly, it is necessary that the arrangement relationship between the input terminals and output terminals of the transmission/reception apparatus to which the connector 10 is to be connected should coincide with the terminal arrangement of the connector 10. In this case, if the connector shape is contrived to cope with such a situation, the electrical input terminals of the optical transmission unit 11 are always connected to the output terminals of the transmission/reception apparatus, and output terminals of the optical reception unit 12 are always connected to the input terminals of the transmission/reception apparatus. Furthermore, it becomes possible to select any one of the connector 10 and connector 20 with respect to connection to an arbitrary transmission/reception apparatus, and it becomes also possible to cope with the so-called reverse connection.

That is, the optical link control units 15 and 16 do not necessarily detect the type of the electronic apparatus, and it becomes sufficient for the units 15 and 16 to detect whether or not an electronic apparatus is connected. The same is true of the connector 20. Accordingly, in this case, when connection of the transmission/reception apparatus is detected at each of connectors 10 and 20 by each of the optical link control units 15, 16, 25, and 26, and turning on of the power of each apparatus is detected, all the switches 17, 18, 27, and 28 may be turned on, and in the case other than the above, all the switches may be turned off.

### Second Embodiment

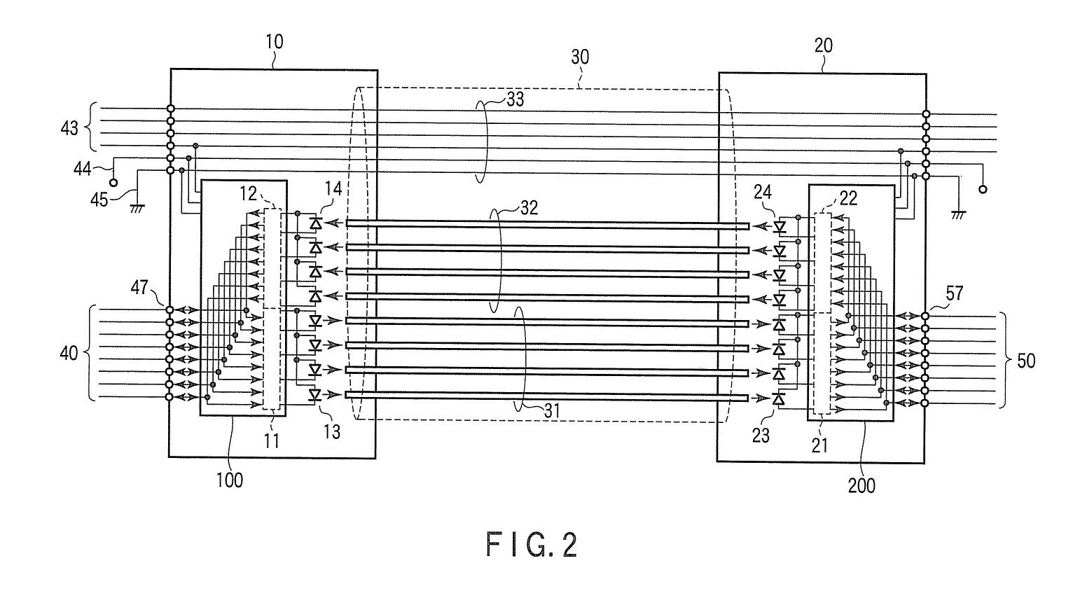

FIG. 2 is a schematic configuration diagram showing an optical wiring cable according a second embodiment. It should be noted that the same parts as those in FIG. 1 are denoted by the same reference symbols as those in FIG. 1, and a detailed description of them will be omitted.

The second embodiment is an example premised on a case where bidirectional transmission is not simultaneously carried out in the first embodiment. In FIG. 2, a reference symbol 40 denotes data signal lines (high-speed signal lines) connected to electrical input/output terminals 47 of a connector 10, reference symbol 50 denotes data signal lines (high-speed signal lines) connected to electrical input/output terminals 57 of a connector 20, and reference symbols 100 and 200 denote optical transmission/reception units each containing an optical transmission unit, and optical reception unit.

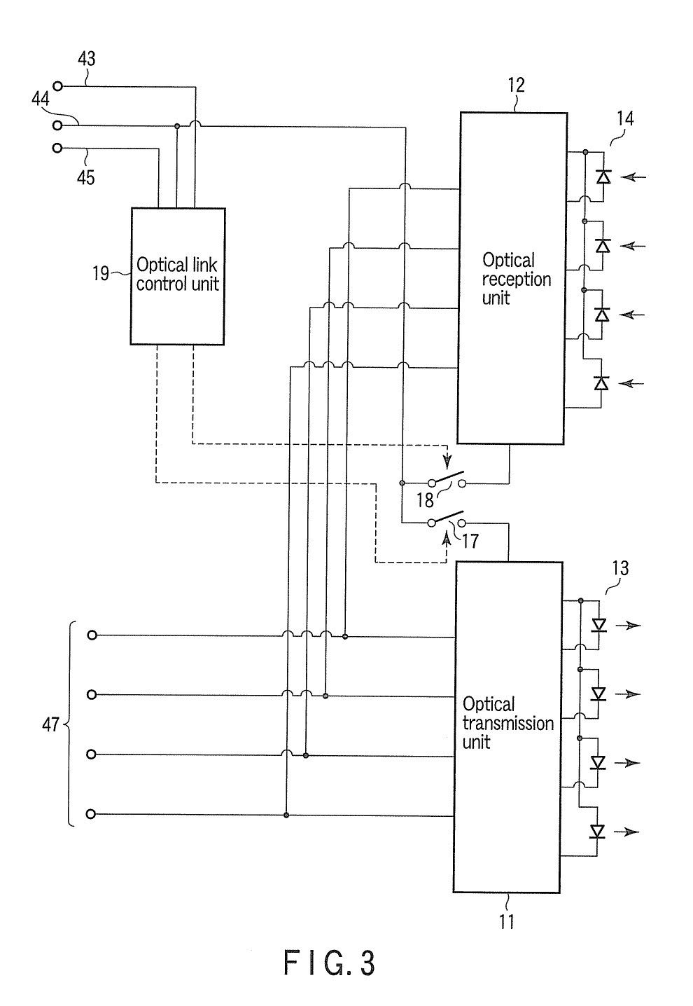

FIG. 3 is a view showing an example of the specific configuration of an optical transmission/reception unit 100 on the connector 10 side. The optical transmission/reception unit 100 includes an optical transmission unit 11, optical reception unit 12, and switches 17 and 18 all of which are described in the first embodiment, and is connected to electrical input/output terminals 47 that are shared by the optical transmission unit 11, and optical reception unit 12 as electrical input terminals, and electrical output terminals, respectively. Further, an optical link control unit 19 configured to detect connection, type, and the like of an electronic apparatus to be connected to the electrical input/output terminals 47, and on/off-control the switches 17 and 18 is provided. It should be noted that the optical transmission/reception unit 200 on the connector 20 side has substantially the same configuration as the above optical transmission/reception unit 100 except that the positional relationship between the optical transmission unit and optical reception unit is reversed.

In this embodiment, it is premised that bidirectional transmission is not carried out, and hence it is possible to use the high-speed lines for carrying out the optical wiring for both transmission and reception, and it is also possible to reduce the number of terminals of the connector, and contribute to the size reduction of the connector and cost reduction. Instead, it is necessary to add a function of determining the type of an apparatus to which the connector 10 or 20 is connected, and turning off the power of one of the optical transmission unit and optical reception unit that becomes unnecessary to each of the optical transmission/reception units 100 and 200. For example, when the electrical input/output terminals 47 are connected to the data transmission apparatus on the connector 10 side, the power of the optical transmission unit 11 is turned on, and power of the optical reception unit 12 is turned off. However, when the electrical input/output terminals 57 on the connector 20 side are also connected to the data transmission apparatus side, the connection is improper connection, and hence the power of each of optical transmission unit 11, and optical reception unit 12 is turned off. This operation also applies to the connector 20 side.

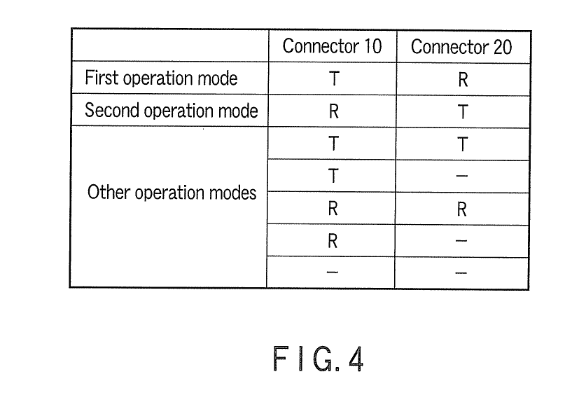

Operation modes based on the types of the electronic apparatuses to which the connector 10 or 20 is connected are as shown in FIG. 4. Here, “T” is a state where a data transmission apparatus is connected to the connector, “R” is a state where a data reception apparatus is connected to the connector, and “—” is a state where nothing is connected to the connector.

In the first operation mode in which the data transmission apparatus is connected to the electrical input/output terminals 47 of the connector 10, and data reception apparatus is connected to the electrical input/output terminals 57 of the connector 20, power is supplied to the optical transmission unit 11 of the optical transmission/reception unit 100 of the connector 10, and power supplied to the optical reception unit 21 of the optical transmission/reception unit 200 of the connector 20. For example, in the connector 10, the switch 17 shown in FIG. 3 is turned on, and switch 18 is turned off.

In the second operation mode in which the data reception apparatus is connected to the connector 10, and data transmission apparatus is connected to the connector 20, power is supplied to the optical reception unit 12 of the optical transmission/reception unit 100 of the connector 10, and power is supplied to the optical transmission unit 22 of the optical transmission/reception unit 200 of the connector 20. For example, in the connector 10, the switch 17 of FIG. 3 is turned off, and switch 18 is turned on.

In the modes other than the above, power supply to the optical transmission unit 11, and optical reception unit 12 of the optical transmission/reception unit 100 of the connector 10 is stopped, and power supply to the optical reception unit 21, and optical transmission unit 22 of the optical transmission/reception unit 200 of the connector 20 is stopped. For example, in the connector 10, both the switches 17 and 18 of FIG. 3 are turned off.

Owing to the configuration described above, power supply to the unnecessary optical transmission unit, and optical reception unit is not carried out, and hence it is possible to prevent useless power consumption, and useless deterioration of the optical wiring cable.

Further, in this embodiment, although simultaneous bidirectional transmission cannot be carried out, the bidirectional transmission is enabled if it is not carried out simultaneously. More specifically, when a data transmission apparatus and data reception apparatus cooperate to exchange their functions of transmission and reception with each other, i.e., when the data transmission apparatus temporarily becomes a data reception apparatus, and data reception apparatus temporarily becomes a data transmission apparatus, data transmission in the reverse direction is enabled. That is, so-called half-duplex transmission is enabled.

### Third Embodiment

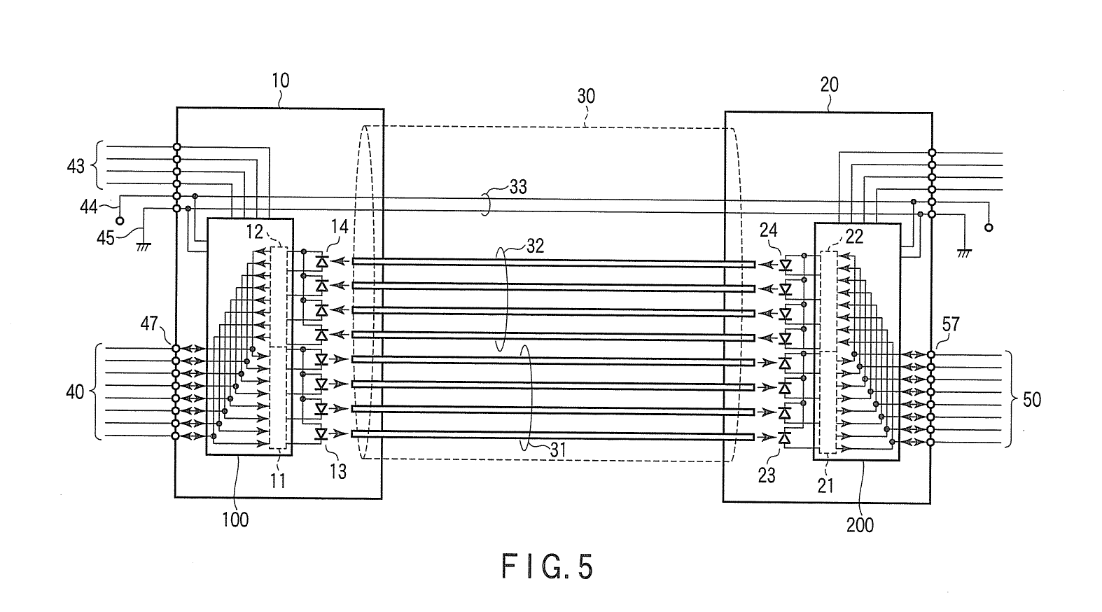

FIG. 5 is a schematic configuration diagram showing an optical wiring cable according to a third embodiment. It should be noted that the same parts as those in FIG. 2 are denoted by the same reference symbols as FIG. 2, and a detailed description of them will be omitted. This embodiment is an example premised on the case where simultaneous bidirectional transmission is not carried out as in the second embodiment.

This embodiment differs from the second embodiment in that control signal lines 43 are not connected between the connector 10 and connector 20 by electrical wires 33, but are data-superposed on an optical signal to be transmitted by the optical interconnection paths 31 and 32.

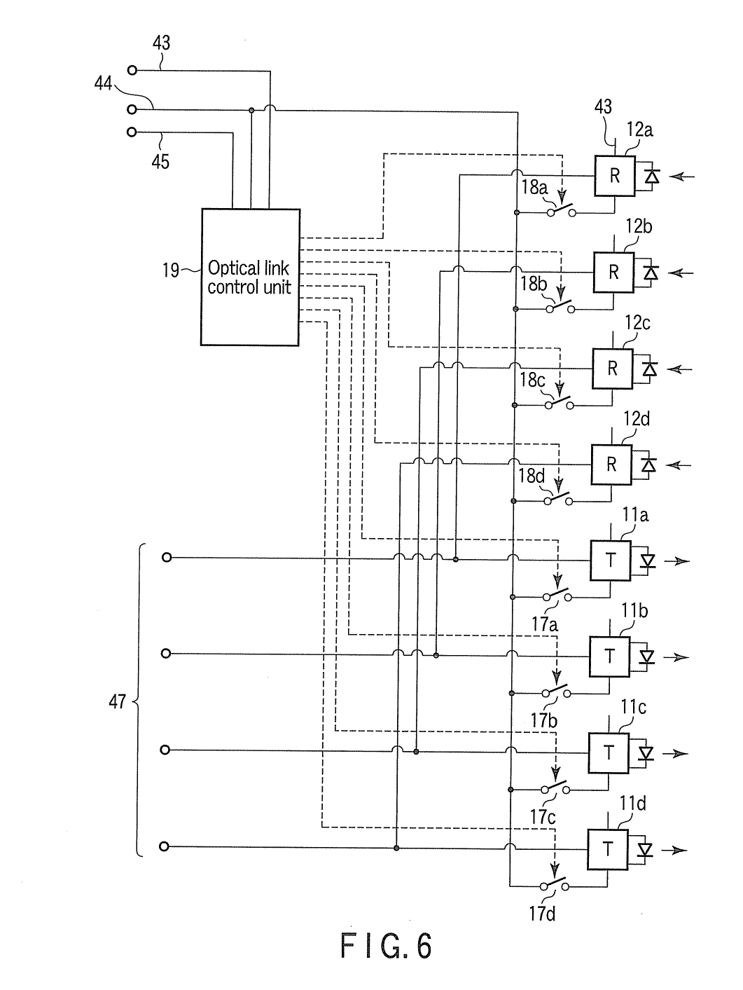

FIG. 6 is a view showing an example of the specific configuration of an optical transmission/reception unit 100 of FIG. 5. The optical transmission/reception unit 100 includes optical transmission units 11 (11a to 11d), optical reception units 12 (12a to 12d), and switches 17 (17a to 17d), and 18 (18a to 18d), and is connected to electrical input/output terminals 47 that are shared by the optical transmission units, and optical reception units as electrical input terminals, and electrical output terminals, respectively. Further, an optical link control unit 19 configured to detect the connection, type, and the like of an electronic apparatus to be connected to the electrical input/output terminals 47, and on/off-control the switches 17 and 18 is provided.

As described above, a switch 17 is independently provided in each optical transmission unit 11, and a switch 18 is independently provided in each optical reception unit 12. Further, the switches 17 and 18 corresponding to each other are not simultaneously turned on, and only one of them can be turned on. For example, the switches 17a and 18a are not simultaneously turned on, and one of turning on of the switch 17a only, turning on of the switch 18a only, and turning off of both the switches 17a and 18a can be selected. It should be noted that the optical transmission/reception unit 200 has substantially the same configuration as the above optical transmission/reception unit 100 except that the positional relationship between the optical transmission units and optical reception units is reversed.

In general, the control signal has a lower speed than the data signal such as an image signal and, even when the control signal is superposed on the data signal, the transmission capacity is not significantly increased. Further, in this embodiment, the optical interconnection paths in the direction reverse to the transmission direction of data can be made inactive, and hence it is possible to carry out bidirectional transmission of a control signal by using part of them.

Thus, in each of the optical transmission/reception units 100 and 200, on the data signal from the high-speed signal lines 40 or 50, a control signal from the control lines 43 in the same direction is superposed and is optically transmitted, and a control signal from the control signal lines 43 in the direction reverse to the data signal is optically transmitted by using optical interconnection paths which are not transmitting a data signal. However, when the control signal in the reverse direction is to be transmitted, it is necessary to temporarily stop the high-speed signal lines of the corresponding optical transmission unit, and optical reception unit. This is carried out in order to prevent the high-speed signal from forming a loop in the paths 31 and 32, and making a circuit to cause oscillation. In general, the control signal lines 43 carry out only one of transmission and reception of a control signal, and carry out half-duplex bidirectional transmission in which simultaneous communication is not carried out, whereby it is possible to realize control signal transmission by the unidirectional optical transmission described above.

At this time, a signal from the control signal line 43 in the direction reverse to the data signal generally does not require large transmission capacity. Accordingly, when there are a plurality of optical interconnection paths as in the case of FIG. 5, it is sufficient if optical wiring is carried out by using only one of the paths, and supply of power to the remaining optical interconnection paths is stopped. Further, in this case, in order that the degree of deterioration of the optical interconnection paths may not become uneven, the optical interconnection path for transmitting the control signal may be periodically switched without transmitting the control signal by always using the same optical interconnection path.

For example, when it is detected that the data transmission apparatus is connected to the electrical input/output terminals 47 of the connector 10 side, and data reception apparatus is connected to the electrical input/output terminals 57 of the connector 20 side, in FIG. 6, one (17d) of the switches 17 is turned off, the remaining switches (17a to 17c) are turned on, one (18d) of the switches 18 is turned on, and the remaining switches (18a to 18c) are turned off. That is, power is supplied to optical transmission units (11a to 11c) other than one of the optical transmission units 11, and to one (12d) of the optical reception units 12. Likewise, on the connector 20 side too, power is supplied to optical reception units other than one of the optical reception units 22, and to one of the optical transmission units 21.

As a result of this, it possible transmit a control signal input from the control signal line 43 to the optical interconnection paths 31 by the optical transmission units 11a to 11c together with a data signal input to the electrical input/output terminal 47. Further, when the control signal is in the reverse direction, it is possible to transmit the control signal of the connector 20 side to the connector 10 side by using part of the optical interconnection paths 32, and detect the transmitted control signal at the optical reception unit 12d.

As described above, according to this embodiment, power is not supplied to the unnecessary optical transmission units and optical reception units, it becomes possible to prevent useless power consumption, and useless deterioration of the optical wiring cable, and it becomes also possible to realize cost reduction achieved by reducing the number of control lines, and reduction in the diameter of the optical wiring cable. Furthermore, even when there is the characteristic depending on the cable length of the control line, e.g., the resistance value limitation or capacity value limitation of the control line, the advantage that the length limitation of the optical wiring cable is largely reduced, and cable length limitation is substantially eliminated is obtained.

It should be noted that in this embodiment too, by leaving the power supply line 44, and grounding line 45 as they are, it becomes possible to supply necessary power from the one connector to both the connectors. As a result of this, even when one of the apparatuses to be connected has small power capacity, it is possible to stably operate the optical wiring cable.

### Fourth Embodiment

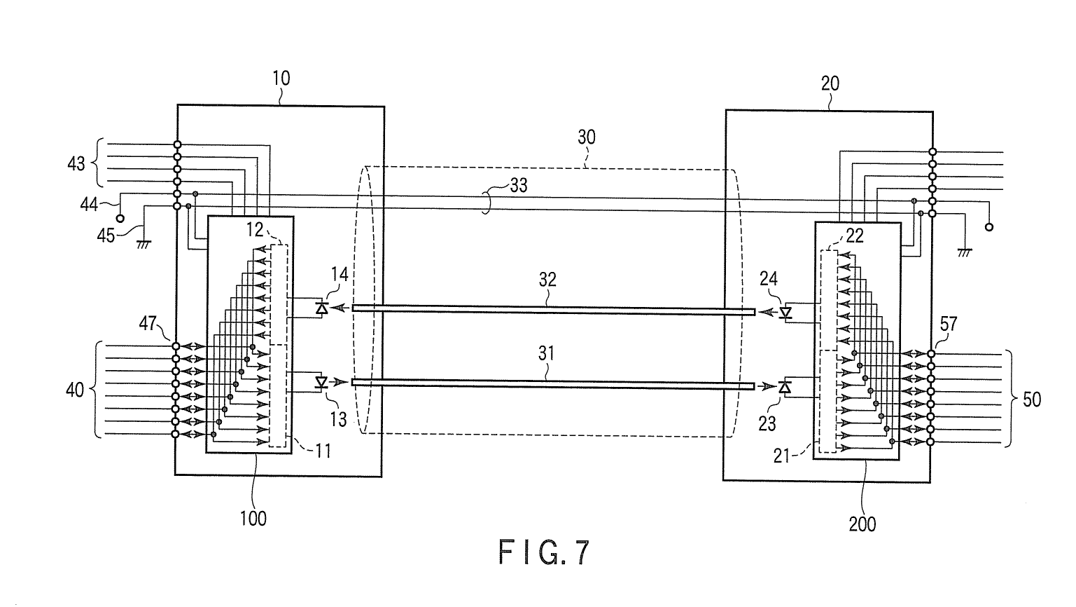

FIG. 7 is a schematic configuration diagram showing an optical wiring cable according to a fourth embodiment. It should be noted that the same parts as those in FIG. 5 are denoted by the same reference symbols as those in FIG. 5, and a detailed description of them will be omitted. This embodiment is an example premised on the case where simultaneous bidirectional transmission is not carried out as in the second embodiment and third embodiment.

This embodiment differs from the third embodiment in that signals from the high-speed signal lines 40 and 50 are unified into one signal, and optical wiring is carried out by only a single path. That is, one optical interconnection path 31 from the connector 10 side to the connector 20 side, and one optical interconnection path 32 from the connector 20 side to the connector 20 side are used.

In this case, the transmission capacity of the optical wiring is increased to three to four times the capacity of the case of FIG. 5. However, for example, the amount of the reproduced image signal of the digital terrestrial broadcasting broadcast in Japan is about 10 Gbps including the RBG signal and clock signal, and hence is a transmission quantity which the optical transmission can sufficiently cope with. Accordingly, in the case of such a use, it is possible to use one optical interconnection path, and carry out optical wiring by unifying the high-speed line signal and control signal into one signal.

Needless to say, regarding the power source control in the case where the optical reception unit becomes unnecessary, it is sufficient if it is carried out in the manner shown in the second embodiment. That is, in the case of improper connection or the off-state of the power, by not carrying out power supply to unnecessary optical transmission unit and optical reception unit, it is possible to prevent useless power consumption, and useless deterioration of the optical wiring cable, this being identical with the previous embodiments. Besides, it becomes also possible to realize cost reduction achieved by reducing the number of control lines and amount of optical wiring, and reduction in the diameter of the optical wiring cable. Furthermore, even when there is the characteristic depending on the cable length of the control line, the advantage that the length limitation of the optical wiring cable is largely reduced, and cable length limitation is substantially eliminated is obtained.

### Fifth Embodiment

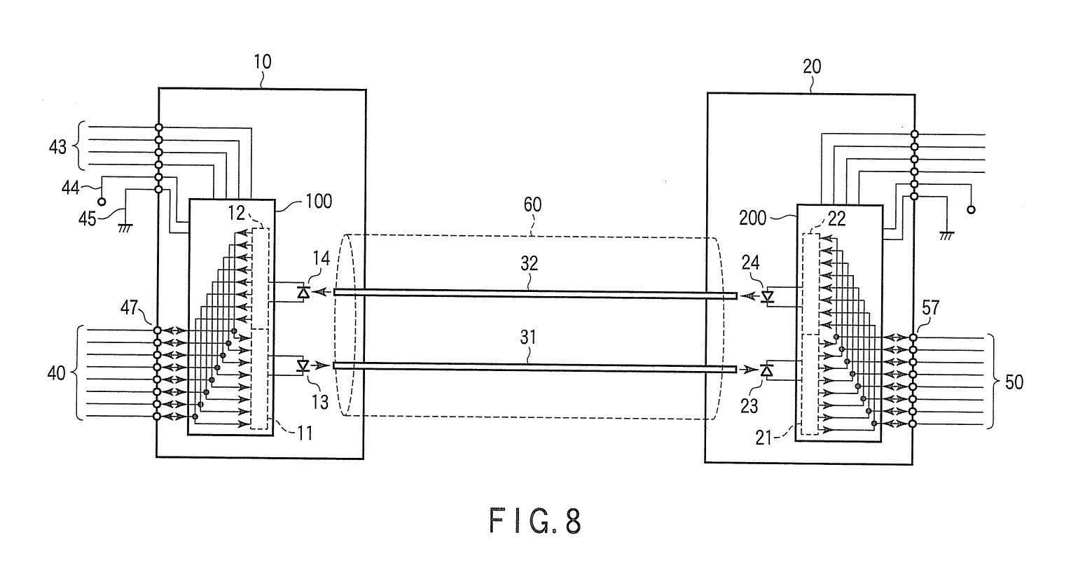

FIG. 8 is a schematic configuration diagram showing an optical wiring cable according to a fifth embodiment. It should be noted that the same parts as those in FIG. 7 are denoted by the same reference symbols as those in FIG. 7, and a detailed description of them will be omitted.

In this embodiment, the electrical wires 33 between the connectors 10 and 20 are omitted from the configuration of the fourth embodiment. That is, although a power supply line 44, and grounding line 45 are connected to the connector 10, they are not extended to the part between the connectors 10 and 20. A power supply line, and grounding line from another connection apparatus are connected to the connector 20.

With such a configuration, although it is possible to supply power to an optical transmission/reception unit 100 in the connector 10 by using, for example, the power supply from an electronic apparatus connected to the connector 10 side, it is not possible to supply power to an optical transmission/reception unit 200 in the connector 20. However, the wiring 60 between the connectors 10 and 20 is constituted only of the optical interconnection paths 31 and 32, and it is possible to simplify the configuration of the cable part.

### Sixth Embodiment

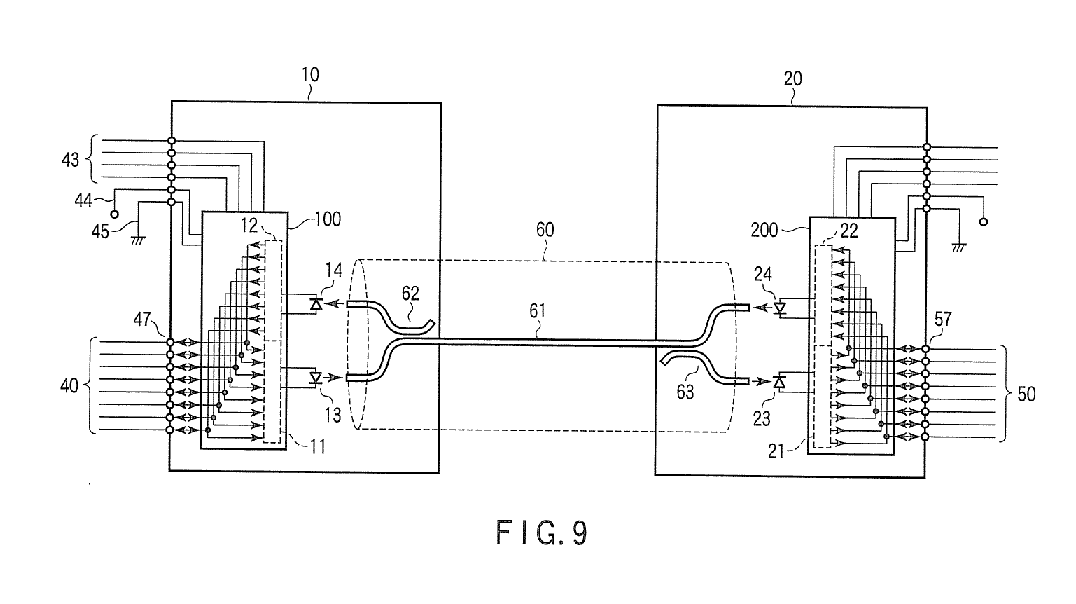

FIG. 9 is a schematic configuration diagram showing an optical wiring cable according to a sixth embodiment. It should be noted that the same parts as those in FIG. 8 are denoted by the same reference symbols as those in FIG. 8, and a detailed description of them will be omitted.

In this embodiment, in addition to the configuration of the fifth embodiment, the optical interconnection paths 31 and 32 are unified into one optical interconnection path 61. When this embodiment is premised on the case where bidirectional transmission is not simultaneously carried out, it is possible to manage with only one optical interconnection path by using a directional coupler 62 or 63 in each of the connectors 10 and 20.

With such a configuration, the same advantage as the fifth embodiment described above can be obtained as a matter of course, and it becomes possible to further simplify the cable part.

### Modification Example

It should be noted that the present invention is not limited to the embodiments described above. For example, although the above-mentioned embodiments show some specific examples, these are only the configuration examples, and other means (circuit, structure, device configuration, and the like) may be used for each individual element in accordance with the spirit of the present invention. Further, the configurations shown in the embodiments are only examples, and the embodiments may be combined with each other to be implemented.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An optical wiring cable configured to convert an electrical signal into an optical signal, and transmit the converted optical signal, comprising:
a single or a plurality of first optical interconnection paths configured to transmit an optical signal in a first direction;
a first optical transmission unit incorporated in a first connector, and configured to transmit an optical signal to the first optical interconnection paths;
a first optical reception unit incorporated in a second connector, and configured to receive an optical signal from the first optical interconnection paths;
a single or a plurality of second optical interconnection paths configured to transmit an optical signal in a direction reverse to the first direction;
a second optical transmission unit incorporated in the second connector, and configured to transmit an optical signal to the second optical interconnection paths;
a second optical reception unit incorporated in the first connector, and configured to receive an optical signal from the second optical interconnection paths; and
a control unit configured to detect a combination of electronic apparatuses to which the first connector and the second connector are to be connected, and control power supply to the first and second optical transmission units, and the first and second optical reception units in accordance with the detected combination, wherein
when the combination corresponds to one of three operation modes including a first operation mode which is signal transmission from the first connector to the second connector, a second operation mode which is signal transmission from the second connector to the first connector, and a third operation mode which is bidirectional signal transmission between the first connector and the second connector,
the control unit carries out power supply to a combination of units which are selected from the first optical transmission unit, the first optical reception unit, the second optical transmission unit, and the second optical reception unit in accordance with one of the first to third operation modes, and stops power supply to remaining units, and
when the combination corresponds to none of the three operation modes, the control unit stops power supply to the first optical transmission unit, the first optical reception unit, the second optical transmission unit, and the second optical reception unit.

2. The cable according to claim 1, wherein
in the first connector, electrical input terminals of the first optical transmission unit and electrical output terminals of the second optical reception unit are provided independently of each other, and in the second connector, electrical output terminals of the first optical reception unit and electrical input terminals of the second optical transmission unit are provided independently of each other.

3. The cable according to claim 2, wherein
the control unit comprises detection circuits configured to detect connection of an electronic apparatus to the terminals of each of the first optical transmission unit, the first optical reception unit, the second optical transmission unit, and the second optical reception unit, and switch circuits configured to turn on/off power supply to the first optical transmission unit, the first optical reception unit, the second optical transmission unit, and the second optical reception unit.

4. The cable according to claim 3, wherein
when it is detected by the detection circuits of the first optical transmission unit and the first optical reception unit that the first optical transmission unit has been connected to a signal transmission apparatus, and the first optical reception unit has been connected to a signal reception apparatus, the switch circuit of each of the first optical transmission unit and the first optical reception unit is turned on, and
when it is detected by the detection circuits of the second optical transmission unit and the second optical reception unit that the second optical transmission unit has been connected to a signal transmission apparatus, and the second optical reception unit has been connected to a signal reception apparatus, the switch circuit of each of the second optical transmission unit and the second optical reception unit is turned on.

5. The cable according to claim 3, wherein
when a combination of results of detection carried out by the detection circuits corresponds to the first operation mode, the switch circuit of each of the first optical transmission unit and the first optical reception unit is turned on, and the switch circuit of each of the second optical transmission unit and the second optical reception unit is turned off,
when the combination of results of detection carried out by the detection circuits corresponds to the second operation mode, the switch circuit of each of the second optical transmission unit and the second optical reception unit is turned on, and the switch circuit of each of the first optical transmission unit and the first optical reception unit is turned off, and
when the combination of results of detection carried out by the detection circuits corresponds to the third operation mode, the switch circuit of each of the first optical transmission unit, the first optical reception unit, the second optical transmission unit, and the second optical reception unit is turned on.

6. The cable according to claim 1, wherein
in the first connector, electrical input terminals of the first optical transmission unit and electrical output terminals of the second optical reception unit are provided independently of each other, and in the second connector, electrical output terminals of the first optical reception unit and electrical input terminals of the second optical transmission unit are provided independently of each other,
the control unit comprises a detection circuit provided in each of the first optical transmission unit, the first optical reception unit, the second optical transmission unit, and the second optical reception unit, and configured to detect connection of an electronic apparatus to the terminals of each unit, and a power supply circuit provided in each of the first optical transmission unit, the first optical reception unit, the second optical transmission unit, and the second optical reception unit,
when it is detected by the detection circuits of the first optical transmission unit and the first optical reception unit that the first optical transmission unit has been connected to a signal transmission apparatus, and the first optical reception unit has been connected to a signal reception apparatus, the power supply circuit of each of the first optical transmission unit and the first optical reception unit is operated, and
when it is detected by the detection circuits of the second optical transmission unit and the second optical reception unit that the second optical transmission unit has been connected to a signal transmission apparatus, and the second optical reception unit has been connected to a signal reception apparatus, the power supply circuit of each of the second optical transmission unit and the second optical reception unit is operated.

7. The cable according to claim 1, wherein
between the first connector and the second connector, electrical wires configured to electrically connect the first connector and the second connector to each other are provided, and the electrical wires are connected to control signal lines, a power supply line, and a grounding line which are connected to electrical terminals provided in each of the first and second connectors.

8. An optical wiring cable configured to convert an electrical signal into an optical signal, and transmit the converted optical signal, comprising:
a single or a plurality of first optical interconnection paths configured to transmit an optical signal in a first direction;
a first optical transmission unit incorporated in a first connector, and configured to transmit an optical signal to the first optical interconnection paths;
a first optical reception unit incorporated in a second connector, and configured to receive an optical signal from the first optical interconnection paths;
a single or a plurality of second optical interconnection paths configured to transmit an optical signal in a direction reverse to the first direction;
a second optical transmission unit incorporated in the second connector, and configured to transmit an optical signal to the second optical interconnection paths;
a second optical reception unit incorporated in the first connector, and configured to receive an optical signal from the second optical interconnection paths; and
a control unit configured to detect a combination of electronic apparatuses to which the first connector and the second connector are to be connected, and control power supply to the first and second optical transmission units, and the first and second optical reception units in accordance with the detected combination, wherein
when the combination corresponds to one of two operation modes including a first operation mode which is signal transmission from the first connector to the second connector, and a second operation mode which is signal transmission from the second connector to the first connector, the control unit carries out power supply to units which are included among the first optical transmission unit, the first optical reception unit, the second optical transmission unit, and the second optical reception unit and which correspond to the operation mode, and stops power supply to remaining units, and
when the combination corresponds to none of the two operation modes, the control unit stops power supply to the first optical transmission unit, the first optical reception unit, the second optical transmission unit, and the second optical reception unit.

9. The cable according to claim 8, wherein
in the first connector, first electrical input/output terminals which are shared by the first optical transmission unit and the second optical reception unit as electrical input terminals and electrical output terminals, respectively are provided, and in the second connector, second electrical input/output terminals which are shared by the first optical reception unit and the second optical transmission unit as electrical output terminals and electrical input terminals, respectively are provided.

10. The cable according to claim 9, wherein
the control unit comprises, in the first connector, a first detection circuit configured to detect the type of an electronic apparatus connected to the first electrical input/output terminals, and a first switch circuit configured to selectively supply power to the first optical transmission unit or the second optical reception unit, and
further comprises, in the second connector, a second detection circuit configured to detect the type of an electronic apparatus connected to the second electrical input/output terminals, and a second switch circuit configured to selectively supply power to the first optical reception unit or the second optical transmission unit.

11. The cable according to claim 10, wherein
when it is detected by the first detection circuit that the first connector has been connected to a signal transmission apparatus and, when it is further detected by the second detection circuit that the second connector has been connected to a signal reception apparatus, power is supplied to the first optical transmission unit by the first switch circuit, and power is supplied to the first optical reception unit by the second switch circuit, and
when it is detected by the first detection circuit that the first connector has been connected to a signal reception apparatus and, when it is further detected by the second detection circuit that the second connector has been connected to a signal transmission apparatus, power is supplied to the second optical reception unit by the first switch circuit, and power is supplied to the second optical transmission unit by the second switch circuit.

12. The cable according to claim 10, wherein
when a combination of results of detection carried out by the detection circuits corresponds to the first operation mode, the first and second switch circuits are operated to carry out power supply to the first optical transmission unit and the first optical reception unit, and stop power supply to the second optical transmission unit and the second optical reception unit,
when the combination of results of detection carried out by the detection circuits corresponds to the second operation mode, the first and second switch circuits are operated to carry out power supply to the second optical transmission unit and the second optical reception unit, and stop power supply to the first optical transmission unit and the first optical reception unit, and
when the combination of results of detection carried out by the detection circuits corresponds to none of the first and second operation modes, all the power supply to be carried out by the first and second switch circuits is stopped.

13. The cable according to claim 8, wherein
in the first connector, first electrical input/output terminals which are shared by the first optical transmission unit and the second optical reception unit as electrical input terminals and electrical output terminals, respectively are provided, and in the second connector, second electrical input/output terminals which are shared by the first optical reception unit and the second optical transmission unit as electrical output terminals and electrical input terminals, respectively are provided,
the control unit comprises, in the first connector, a first detection circuit configured to detect the type of an electronic apparatus connected to the first electrical input/output terminals, and a first power supply circuit configured to selectively supply power to the first optical transmission unit or the second optical reception unit, and further comprises, in the second connector, a second detection circuit configured to detect the type of an electronic apparatus connected to the second electrical input/output terminals, and a second power supply circuit configured to selectively supply power to the first optical reception unit or the second optical transmission unit,
when a combination of results of detection carried out by the detection circuits corresponds to the first operation mode, the first and second power supply circuits are operated to carry out power supply to the first optical transmission unit and the first optical reception unit, and stop power supply to the second optical transmission unit and the second optical reception unit,
when the combination of results of detection carried out by the detection circuits corresponds to the second operation mode, the first and second power supply circuits are operated to carry out power supply to the second optical transmission unit and the second optical reception unit, and stop power supply to the first optical transmission unit and the first optical reception unit, and
when the combination of results of detection carried out by the detection circuits corresponds to none of the first and second operation modes, the first and second power supply circuits are stopped.

14. The cable according to claim 8, wherein
between the first connector and the second connector, electrical wires configured to electrically connect the first connector and the second connector to each other are provided, and the electrical wires are connected to control signal lines, a power supply line, and a grounding line which are connected to electrical terminals provided in each of the first and second connectors.

15. The cable according to claim 8, wherein
the number of the first optical interconnection path is one, and the numbers of the first optical transmission units and the first optical reception units are plural, and
the number of the second optical interconnection path is one, and the numbers of the second optical transmission units and the second optical reception units are plural.

16. The cable according to claim 15, wherein
one optical interconnection path is shared by the first optical interconnection path and the second optical interconnection path by providing a directional coupler on each of the first connector side and the second connector side.

17. An optical wiring cable configured to convert an electrical signal into an optical signal, and transmit the converted optical signal, comprising:
a plurality of first optical interconnection paths configured to transmit an optical signal in a first direction;
a first optical transmission unit incorporated in a first connector, and configured to transmit an optical signal to the first optical interconnection paths;
a first optical reception unit incorporated in a second connector, and configured to receive an optical signal from the first optical interconnection paths;
a plurality of second optical interconnection paths configured to transmit an optical signal in a direction reverse to the first direction;
a second optical transmission unit incorporated in the second connector, and configured to transmit an optical signal to the second optical interconnection paths;
a second optical reception unit incorporated in the first connector, and configured to receive an optical signal from the second optical interconnection paths; and
a control unit configured to detect a combination of electronic apparatuses to which the first connector and the second connector are to be connected, and control power supply to the optical transmission units, and the optical reception units in accordance with the detected combination, wherein
when the combination corresponds to a first operation mode which is signal transmission from the first connector to the second connector, the control unit transmits a control signal by means of the first optical interconnection paths together with a data signal, and transmits a control signal by means of part of the second optical interconnection paths,
when the combination corresponds to a second operation mode which is signal transmission from the second connector to the first connector, the control unit transmits a control signal by means of the second optical interconnection paths together with a data signal, and transmits a control signal by means of part of the first optical interconnection paths, and
when the combination corresponds to none of the first and second operation modes, the control unit stops the power supply to the first optical transmission unit, the first optical reception unit, the second optical transmission unit, and the second optical reception unit.

18. The cable according to claim 17, wherein
in the first connector, first electrical input/output terminals which are shared by the first optical transmission unit and the second optical reception unit as electrical input terminals and electrical output terminals, respectively are provided, and in the second connector, second electrical input/output terminals which are shared by the first optical reception unit and the second optical transmission unit as electrical output terminals and electrical input terminals, respectively are provided.

19. The cable according to claim 17, wherein
the number of the first optical interconnection path is one, and the numbers of the first optical transmission units and the first optical reception units are plural, and
the number of the second optical interconnection path is one, and the numbers of the second optical transmission units and the second optical reception units are plural.

20. The cable according to claim 17, wherein
one optical interconnection path is shared by the first optical interconnection path and the second optical interconnection path by providing a directional coupler on each of the first connector side and the second connector side.
